(19) United States
(12) Patent Application Publication
(10) Pub. No.: US 2020/0248652 A1
(43) Pub. Date: Aug. 6, 2020

(54) Method for Operating a Gas Engine or a Dual-Fuel Engine Operated in a Gas Fuel Operating Mode and Corresponding Engine

(71) Applicant: MAN Energy Solutions SE, Augsburg (DE)

(72) Inventors: Sascha STOLL, Ellgau (DE); Stefan Terbeck, Augsburg (DE); Hans-Philipp Walther, Kutzenhausen (DE); Anton Krauss, Kissing (DE)

(73) Assignee: MAN Energy Solutions SE

(21) Appl. No.: 16/782,854

(22) Filed: Feb. 5, 2020

(30) Foreign Application Priority Data
Feb. 6, 2019 (DE) 10 2019 102 887.6

(51) Int. Cl. F02M 21/04; F02M 21/02; F02D 19/02

(52) U.S. Cl. CPC F02M 21/04; F02D 19/023; F02M 21/0239

(57) ABSTRACT

A method for operating a gas engine, or a dual-fuel engine operated in a gas fuel operating mode, the gas engine having a plurality of cylinders, structured to withstand ignition and combustion of an ignitable mixture of a gaseous fuel and combustion air, includes: preparing a non-ignitable premixture of the combustion air and the gaseous fuel; conducting the non-ignitable premixture toward the cylinders; adding further gaseous fuel to the non-ignitable premixture upstream of an inlet-side gas exchange valve via a gas valve assigned to a respective cylinder, so as to convert the non-ignitable premixture into the ignitable mixture; conducting, via the combustion air line, the ignitable mixture toward the cylinders; and providing the ignitable mixture to the respective cylinders.

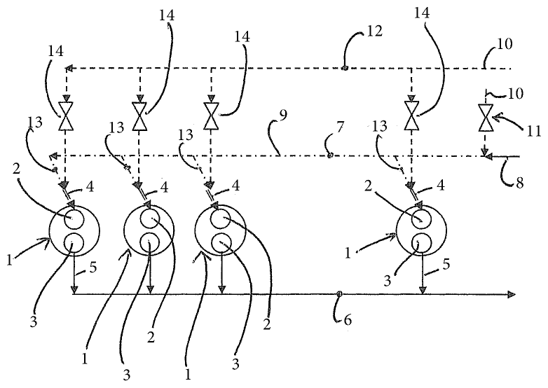

### BACKGROUND OF THE INVENTION

### 1. Field of the Invention

The invention relates to a method for operating a gas engine or a dual-fuel engine operated in a gas fuel operating mode.

### 2. Description of the Related Art

A dual-fuel engine is an internal combustion engine in which both gaseous fuel in a gas fuel operating mode, and also liquid fuel in a liquid fuel operating mode, can be combusted. In the liquid fuel operating mode, liquid fuel, such as for example heavy fuel oil, is fed to the cylinders by fuel injectors, wherein the liquid fuel is combusted in the presence of combustion air, which combustion air is fed to the cylinders via inlet-side gas exchange valves. Exhaust gas generated in the process is discharged by exhaust-side gas exchange valves. In the gas fuel operating mode, a gaseous fuel, such as for example natural gas, is combusted in the cylinders of a dual-fuel engine. In the process, a mixture of gaseous fuel and combustion air is fed to the cylinders via the inlet-side gas exchange valves, wherein exhaust gas in turn is discharged via the exhaust-side gas exchange valves. In the case of dual-fuel engines, ignition oil serves for igniting the mixture of gaseous fuel and combustion air in the gas fuel operating mode. The ignition oil is the liquid fuel that is combusted in the liquid fuel operating mode. Dependent on the embodiment of the fuel injectors, the liquid fuel serving as ignition oil can be fed to the cylinders in the gas fuel operating mode via the same fuel injectors via which the liquid fuel is fed to the cylinders in the liquid fuel operating mode. However, it is also possible to assign separate ignition oil injectors to the cylinders via which the liquid fuel serving as ignition oil in the gas fuel operating mode is fed to the cylinders.

In a gas engine, exclusively gaseous fuel is combusted, wherein a mixture of gaseous fuel and combustion air is fed to the cylinders of a gas engine via the inlet-side gas exchange valves. This mixture of gaseous fuel and combustion air is ignited via a spark plug in the case of a gas engine.

Accordingly, a mixture of gaseous fuel and combustion air is fed to the cylinders of the engine both in the case of a gas engine and also in the case of a dual-fuel engine operated in the gas fuel operating mode, ignited and combusted in the cylinders. The mixture of the gaseous fuel and the combustion air is provided for the respective cylinder in that upstream of the inlet-side gas exchange valve of the respective cylinder gaseous metered fuel is added to the combustion air, which is conducted in the direction of the cylinders via a combustion air line, namely cylinder-individually via a gas valve assigned to the respective cylinder.

The quantity of gaseous fuel that can be added in a metered manner to the combustion air via the respective gas valve is dependent on the maximum opening duration of the respective gas valve. The maximum gas quantity that can be added in a metered manner correlates to the maximum energy content of the mixture of gaseous fuel and combustion air fed to the respective cylinder. When the gaseous fuel has a low calorific value and accordingly a low energy content, it can be, under certain conditions, that the energy content of the mixture of gaseous fuel and combustion air to be combusted in the cylinder is not sufficiently high for a stable combustion.

There is a need for operating a gas engine or a dual-fuel engine operated in a gas fuel operating mode with a more stable combustion.

### SUMMARY OF THE INVENTION

Starting out from this, it is an object of the invention to create a new type of method for operating a gas engine or a dual-fuel engine operated in a gas fuel operating mode. This object is solved through a method according to the invention.

According to an aspect of the invention, a non-ignitable premixture of combustion air and gaseous fuel is conducted via the combustion air line in the direction of the cylinders. Further gaseous fuel is cylinder-individually added in a metered manner to the non-ignitable premixture of combustion air and gaseous fuel via the gas valve assigned to the respective cylinder in order to convert the non-ignitable premixture of combustion air and gaseous fuel into the ignitable mixture of combustion air and gaseous fuel.

With the method according to an aspect of the invention, it is not pure combustion air that is conducted in the direction of the cylinders in the combustion air line but rather a non-ignitable premixture of combustion air and gaseous fuel, the energy content of which is below a so-called explosion limit for the mixture of combustion air and gaseous fuel. Upstream of the respective inlet-side gas exchange valve, gaseous fuel is cylinder-individually added in a metered manner via the gas valve assigned to the respective cylinder to this premixture of combustion air and gaseous fuel that is the same for the cylinders, in order to thereby convert the non-ignitable premixture of combustion air and gaseous of a mixture fuel into the ignitable mixture of combustion air and gaseous fuel. The maximum energy content of combustion air and gaseous fuel to be combusted in a cylinder is consequently no longer limited by the maximum opening duration of the gas valve but this energy content can rather be increased in that the premixture of gaseous fuel and combustion air is conducted via the combustion air line, which premixture is not yet ignitable however, but whose mixing ratio is below the explosion limit of the mixture of gaseous fuel and combustion air.

According to an advantageous further development, the mixing ratio of the non-ignitable premixture of combustion air and gaseous fuel is adjusted dependent on energy content of the gaseous fuel. With this further development, a safe and efficient operation of the respective engine is possible. The mixing ratio of the premixture of combustion air and gaseous fuel to be conducted via the combustion air line is adjusted, dependent on the energy content of the gaseous fuel, so that the same is not ignitable.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWING

Preferred further developments of the invention are set forth in the following description. Exemplary embodiments of the invention are explained in more detail by way of the drawing without being restricted to this.

The FIGURE is a schematic view of an internal combustion engine illustrating an aspect of the method according to the invention.

### DETAILED DESCRIPTION OF THE PRESENTLY PREFERRED EMBODIMENTS

Each cylinder 1 comprises at least one inlet-side gas exchange valve 2 and at least one outlet-side gas exchange valve 3. By way of the respective inlet-side gas exchange valve 2, an ignitable mixture of gaseous fuel 10 and combustion air 8 can be fed to the respective cylinder 1, wherein this mixture of the gaseous fuel 10 and the combustion air 8 is ignited and combusted in the cylinders 1. Exhaust gas 5 generated in the process can be discharged from the cylinders 1 via the exhaust-side gas exchange valves 3 and conducted via an exhaust line 6 in the direction of an exhaust gas after-treatment system (not shown).

The mixture 4 of the gaseous fuel 10 and the combustion air 8, which is fed to the cylinders 1 via the inlet-side gas exchange valves 2 is an ignitable mixture 4 of gas and combustion air, which, in the case of a gas engine, is ignited with the help of a spark plug of the respective cylinder 1.

The FIGURE shows a combustion air line 7, via which combustion air 8 can be conducted in the direction of the cylinders 1. Here it is not pure combustion air 8 that is conducted in the direction of the cylinder 1 via the combustion air line 7 but rather a premixture 9 of combustion air 8 and gaseous fuel 10, which is non-ignitable. The mixing ratio of this premixture 9 of gaseous fuel 8 and combustion air 10 accordingly is below a so-called explosion limit.

The FIGURE shows a metering device 11, such as a nozzle or valve via which gaseous fuel 10 can be added to the combustion air 8 in a metered manner, namely in a mixing ratio of gaseous fuel 10 and combustion air 8 that is common to all cylinders 1 which are supplied with combustion air via the combustion air line 7.

Furthermore, The FIGURE shows a gas line 12 via which the gaseous fuel 10 can be conducted in the direction of the individual cylinders 1 in order to mix the gaseous fuel 10 conducted via the gas line 12 in the direction of the cylinders 1 upstream of the respective inlet-side gas exchange valve 2 of the respective cylinder 1 in the region of a branch 13 branching off the combustion air line 7, which leads to the respective cylinder 1, with the premixture 9.

By mixing the premixture 9 of combustion air 8 and gaseous fuel 10 with the further gaseous fuel 10 conducted via the gas line 12 the mixture 4 of gaseous fuel 10 and combustion air is created, which is ignitable.

From The FIGURE it is evident that each cylinder 1 is assigned a gas valve 14, via which a further gaseous fuel 10 can be added cylinder-individually to the premixture 9 of combustion air 8 and gaseous fuel 10 in a metered manner, namely in the region of the branch 13 leading to the respective cylinder 1 branching off the combustion air line 7 directly upstream of the respective inlet-side gas exchange valve 2 of the respective cylinder 1.

Accordingly, with the present invention it is proposed to not exclusively conduct combustion air 8 via the combustion air line 7 leading to the cylinders 1 but rather a non-ignitable premixture 9 of gaseous fuel 10 and combustion air 8. This premixture 9 is identical for all cylinders 1.

Upstream of the respective cylinder 1, a further gaseous fuel 10 is added in a metered manner to this premixture 9 of combustion air 8 and gaseous fuel 10, namely via the gas valve 14 assigned to the respective cylinder 1, via which further gaseous fuel 10 can be fed to the respective cylinder 1 cylinder-individually directly upstream of the respective inlet-side gas exchange valve 2 in order to convert the premixture 9 into an ignitable mixture 4 of gaseous fuel 10 and combustion air 8.

The mixing ratio of the premixture 9 of combustion air 8 and gaseous fuel 10 is determined as a function of the energy content of the gaseous fuel 10 namely such that the premixture 9 is non-ignitable, i.e., its mixing ratio is below a so-called explosion limit. In this manner, the engine can be safely and efficiently operated.

The energy content of the mixture 4 of gaseous fuel 10 and combustion air 8 to be combusted in the cylinder is no longer dependent on the maximum opening duration of the gas valves 14 but can rather be increased by way of the mixing ratio of the premixture 9. In this manner, a stable operation of the engine is possible in particular when a gaseous fuel with low energy content is to be combusted.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

### LIST OF REFERENCE NUMBERS

1 Cylinder
2 Inlet-side gas exchange valve
3 Exhaust-side gas exchange valve
4 Mixture
5 Exhaust gas
6 Exhaust line
7 Combustion air line
8 Combustion air
9 Premixture
10 Gaseous fuel
11 Metering device
12 Gas line
13 Branch
14 Gas valve

1. A method for operating a gas engine, or a dual-fuel engine operated in a gas fuel operating mode, the gas engine having a plurality of cylinders (1), each of the cylinders (1) being structured to withstand ignition and combustion of an ignitable mixture (4) of a gaseous fuel (10) and combustion air (8) within the cylinder, the method comprising:
preparing a non-ignitable premixture (9) of the combustion air (8) and the gaseous fuel (10);
conducting, via a combustion air line (7), the non-ignitable premixture (9) of the combustion air (8) and the gaseous fuel (10) toward the cylinders (1);
adding, cylinder-individually in a metered manner, further gaseous fuel (10) to the non-ignitable premixture (9) of the combustion air (8) and the gaseous fuel (10) upstream of an inlet-side gas exchange valve (2) via a gas valve (14) assigned to a respective cylinder (1), so as to convert the non-ignitable premixture (9) of the combustion air (8) and the gaseous fuel (10) into the ignitable mixture (4) of the combustion air (8) and the gaseous fuel (10);
conducting, via the combustion air line (7), the ignitable mixture (4) of the gaseous fuel (10) and the combustion air (8) toward the cylinders (1); and
providing the ignitable mixture (4) of the gaseous fuel (10) and the combustion air (8) to the respective cylinders (1).

2. The method according to claim 1, wherein a mixing ratio of the non-ignitable premixture (9) of the combustion air (8) and the gaseous fuel (10) is adjusted dependent on an energy content of the gaseous fuel (10).

3. The method according to claim 2, wherein the mixing ratio of combustion air (8) and gaseous fuel (10) of the non-ignitable premixture (9) is adjusted jointly for all cylinders (1).

4. A gas engine or dual-fuel engine, comprising:
a plurality of cylinders (1) each comprising an inlet-side gas exchange valve (2) and an exhaust-side gas exchange valve (3);
a combustion air line (7) via which combustion air (8) is conductible in a direction of the inlet-side gas exchange valves (2) of the respective cylinders (1),
branches (13) leading from the combustion air line (7) to the respective inlet-side gas exchange valves (2) of the cylinders (1),
a gas line (12) coupled with gas valves (14) assigned to the respective cylinders (1), via which upstream of the respective inlet-side gas exchange valves (2) of the respective cylinders (1) the combustion air (8) conductible to the respective cylinders (1) is mixable with gaseous fuel (10), to provide the respective cylinder (1) with an ignitable mixture (4) of the gaseous fuel (10) and combustion air (8), which is ignitable and combustible in the cylinders (1),
wherein
the combustion air line (7) is configured to conduct a non-ignitable premixture (9) of the combustion air (8) and the gaseous fuel (10) toward the cylinders (1), and
the engine is configured to cylinder-individually add, in a metered manner, further gaseous fuel (8) to the non-ignitable premixture (9) of the combustion air (8) and the gaseous fuel (10) upstream of the inlet-side gas exchange valve (2) via the gas valve (14) assigned to the respective cylinder (1), to convert the non-ignitable premixture (9) of the combustion air (8) and the gaseous fuel (10) into the ignitable mixture (4) of the combustion air (8) and the gaseous fuel (10).

5. The gas engine or dual-fuel engine according to claim 4, further comprising a metering device (11) for gaseous fuel (10) assigned to the combustion air line (7), via which the mixing ratio of combustion air (8) and gaseous fuel (10) of the non-ignitable premixture (9) is jointly adjustable for all cylinders (1).
